(19) United States
(12) Patent Application Publication
(10) Pub. No.: US 2012/0284310 A1
(43) Pub. Date: Nov. 8, 2012

(54) Electronic Management System for Authoring Academic Works

(75) Inventor: LeRoy Yager, Phoenix, AZ (US)

(73) Assignee: MALACHI VENTURES, LLC, Phoenix, AZ (US)

(21) Appl. No.: 13/461,671

(22) Filed: May 1, 2012

Related U.S. Application Data
(60) Provisional application No. 61/481,644, filed on May 2, 2011.

(51) Int. Cl. G06F 7/00; G06F 17/30; G06F 15/16

(52) U.S. Cl. 707/803; 709/218; 707/E17.045

(57) ABSTRACT

An electronic management system accessible over the internet manages the elements of a user's large-scale writing project. The user enters or otherwise uploads project data including main document data and research data and the system organizes the data according to the needs of the writer, preferably using a hierarchy that conforms to the logical progression of the written work. The system manages referential linkages between the different types of data in order to maintain consistency across stored data when it is updated. The system may compile or consolidate data and generate reports that the writer uses while proceeding through the project, including calculations relating to the type, age, and number of references cited in the project. The system may interface with other software programs, such as word processors, data processors, and online libraries, to export or import data related to the project.

### CROSS-REFERENCE TO RELATED APPLICATIONS

This application is a nonprovisional and claims the benefit of provisional patent application Ser. No. 61/481,644, filed May 2, 2011.

### FIELD OF INVENTION

This invention relates to the authoring of academic writing projects. This invention relates particularly to a method and apparatus for electronically managing a writing project and its associated documentation.

### BACKGROUND

Academic students from the high-school to doctoral level are assigned or take on paper-writing projects that require a great deal of time researching the subject of the project and writing the paper so that it correctly cites and catalogs research sources. The projects become greater in complexity and length and are subject to increasingly stringent requirements for supporting research as the student progresses toward the graduate, master's degree, and doctorate levels. It is common for a doctoral dissertation to cite over 400 sources of supporting research, including treatises, books, journals, articles, essays, and other sources. The average length of a cited reference in a dissertation is about 16 pages. Thus, the writer is obligated to review and keep track of, on average, over 6400 pages of reference material throughout the course of the project.

Keeping supporting research organized is essential to the project for many reasons, including: to track the source of facts and theories; to properly locate and recite quotations; to build a bibliography; to retain citations in their proper place when the paper is restructured or otherwise revised; to update research results; to maintain and compare hierarchies of developing theories; to ascertain the evolution of a certain writer's works; to compile survey results; and to otherwise quantify or qualify the results of the writer's research. However, it is difficult for one person to organize and document such a high volume of material, particularly when only small amounts of data from references is needed. For the most part, tracking the supporting research by hand has given way to doing so electronically, such as with spreadsheets or other data processing programs that are not specific to academic writing projects.

This lack of specificity significantly affects the efficiency and reliability of managing the writing project electronically. First, the writer must have some familiarity and capability of using such programs. Then, the writer must adapt the program to suit his needs. The adaptation may be an ongoing process; i.e., the writer may continue to identify elements of each reference that should be tracked as the project progresses, and the writer then has to return to previously-logged references to add the newly identified essential elements. Such iterative and repetitive data entry wastes time and invites mistakes. A system for electronically managing the writing project and its associated documentation is needed.

There are many reference management software packages that address some of the organizational issues a writer faces. Primarily, these packages help the writer generate bibliographies by storing certain subsets of information about cited references. Some software has additional functionality, such as generating categorized lists of references, searching standardized databases such as Z39.50 online libraries, and integrating with common word processors so properly-formatted citations can be inserted and maintained in a developing paper. However, no known software package addresses all of the needs of an academic writer. Particularly, no software allows the writer to trace and compare the hierarchical development of competing theories on the subject matter; to store data collected outside of cited references, such as by survey; or to standardize the writer's notes on references across one or more categories of references. An electronic system that provides a comprehensive set of features to the academic writer is needed.

All writers' work is susceptible to data loss when done electronically, as personal computers tend to break or be stolen at the most inopportune times. The risk to a writer's data is exacerbated by the typical length of in-depth projects like theses and dissertations. It would be advantageous to provide a research management system that allows a writer to store information online, limiting the risk of data loss and providing more flexible accessibility to stored data.

Therefore, it is an object of this invention to provide to a writer a system and methods for electronically managing a writing project and its associated documentation. It is a further object that the system be more efficient and reliable than known electronic systems. It is a further object that the system be configurable for any type of academic writing project. It is another object to provide an electronic research organization system that allows a writer to store research results according to a hierarchy that conforms to a writing project. It is a further object that the writer be able to access the system over the internet.

### SUMMARY OF THE INVENTION

The invention is an electronic system, preferably accessible over the internet, which manages the elements of one or more large-scale writing projects. The elements to be managed may include main document data pertaining to the actual contents of the written work to be produced in the project, research data pertaining to references the writer has reviewed and experiments or studies the writer has performed, and topic data pertaining to the categorization of information conveyed in the written work. The system organizes the data according to the needs of the writer, preferably using a hierarchy that conforms to the logical progression of the written work. The system manages referential linkages between the different types of data in order to maintain consistency across stored data when it is updated. The system may compile or consolidate data and generate reports that the writer uses while proceeding through the project. The system may interface with other software programs, such as word processors, data processors, and online libraries, to export or import data related to the project.

### BRIEF DESCRIPTION OF THE DRAWINGS

FIG. 1 is a diagram illustrating project data.

FIG. 2 is a diagram illustrating the typical user navigation options within a project as managed by the system.

FIG. 3 is a diagram illustrating referential linkages between main document data, reference records, and topic data.

FIG. 4 is a screenshot of an example chapter outline.

FIG. 5 is a screenshot of linking a reference with a chapter outline.

FIG. 6 is a screenshot of research data entered into a reference record.

FIG. 7 is a screenshot of experimental data entry.

FIG. 8 is a screenshot of an example report produced by the system.

### DETAILED DESCRIPTION OF THE INVENTION

The present invention is a system for organizing, managing, and updating the elements of one or more large-scale writing projects. In one embodiment, the system may be implemented as a self-contained computer program product, which the writer installs and uses on his personal computer. This embodiment may conform to any programming design that is suitable for performing the functional requirements described below. In the preferred embodiment, the system is implemented for the writer's use over the internet or another computer network. The preferred system follows a programming design that utilizes a plurality of internet application programming tools. These tools may perform dynamic content generation, data processing and storage, secure access management, communication with third party software, site mapping, electronic messaging, and other functions. The tools may include software modules programmed with HTML, XML, Java, JavaScript, Active Server Pages (“ASP”), AJAX, C#, MicroSoft .NET framework, SQL, ODBC, and similar programming and querying languages and associated user control interfaces.

At least one relational database management system is used to manage the project data as described below. For purposes of efficient data access and system scalability, the project data may be divided into one or more data stores and may be stored in a single database or across a plurality of databases residing in the memory of one or more servers. Elements of the project data may also or alternatively be organized according to a hierarchical file folder system as is well-known in software application environments. The system may link to an external word processing or spreadsheet program in order to import and export modifications to the project data, allowing real-time updating of documents produced for the written work. Alternatively, the system may store and manage the documents produced for the written work as main document data, according to the collection and storage framework described below.

Project Data

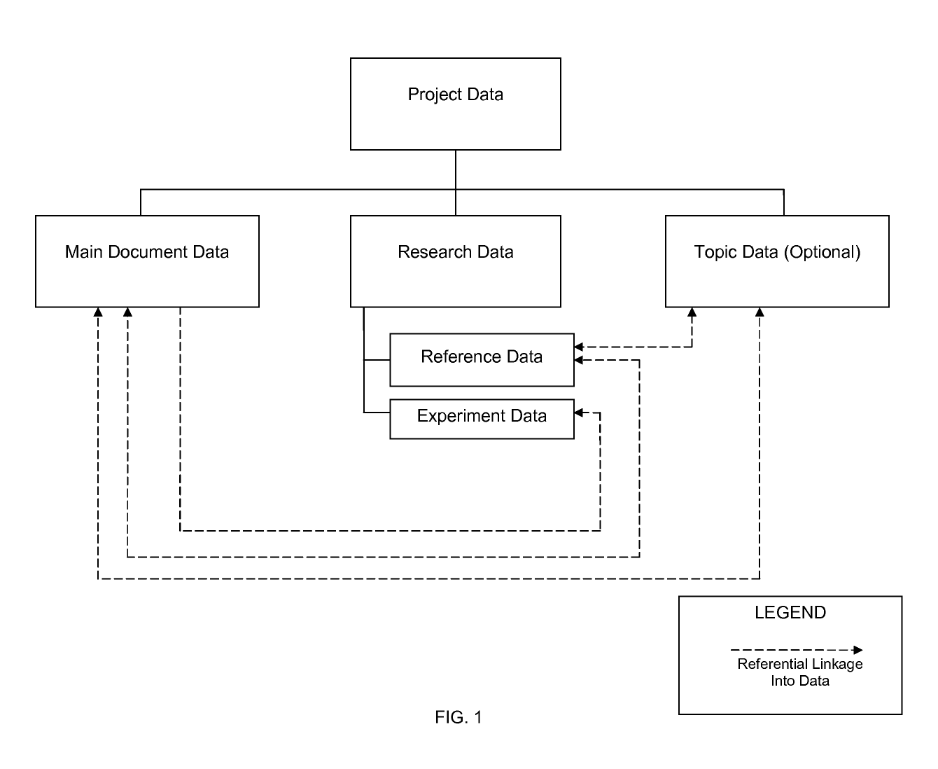

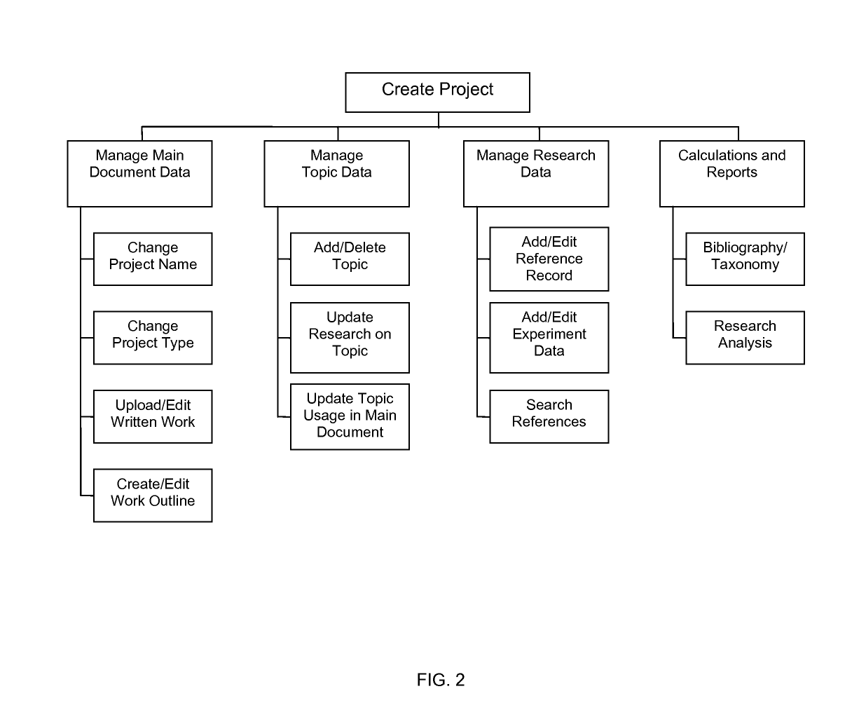

Referring to FIGS. 1-3, the system creates a project and then collects the project data for organizing and presenting to the writer. The project data may be collected by the writer's or another person's manual input, by automated retrieval such as linking to or downloading project data on the internet, or by a combination of manual and automated retrieval. The project data is preferably stored categorically, with related data being stored in the same or related records. The project data may be divided into the categories of main document data and research data, and may further be divided into the category of topic data. After initial collection of any data, the system may update and manage the collected data upon manual user-entry or automatically as described above.

Main document data is data that relates to the actual content of the written work to be produced in the writing project. The written work may be an academic work, such as a dissertation, thesis, biography, or book report; a professional work, such as a market analysis or corporate history; a pure research work, such as a scientific journal article or clinical study; or another type of written work. The main document data may include the text of the written work, including titles, subtitles, and headings; versions and revision data for the written work; a work outline, which may be divided into chapter and subchapter outlines; a table of contents; reference citations, stored in the proper format for printing in the written work; and one or more bibliographies. The main document data may include self-referential linkages in order to maintain the structure of the written work. For example, each title, subtitle, heading, and reference citation may include the page number on which it appears, the page number being automatically updated when the written work is revised. The table of contents and bibliography may be accurately maintained by referencing the page numbers. The main document data may also include referential linkages to project data in other categories, and may further allow such project data to link to it. For example, reference data includes reference records as described below. If the page number of a quote stored in a reference record is updated, the reference citation is automatically updated to reflect the quote's new page number.

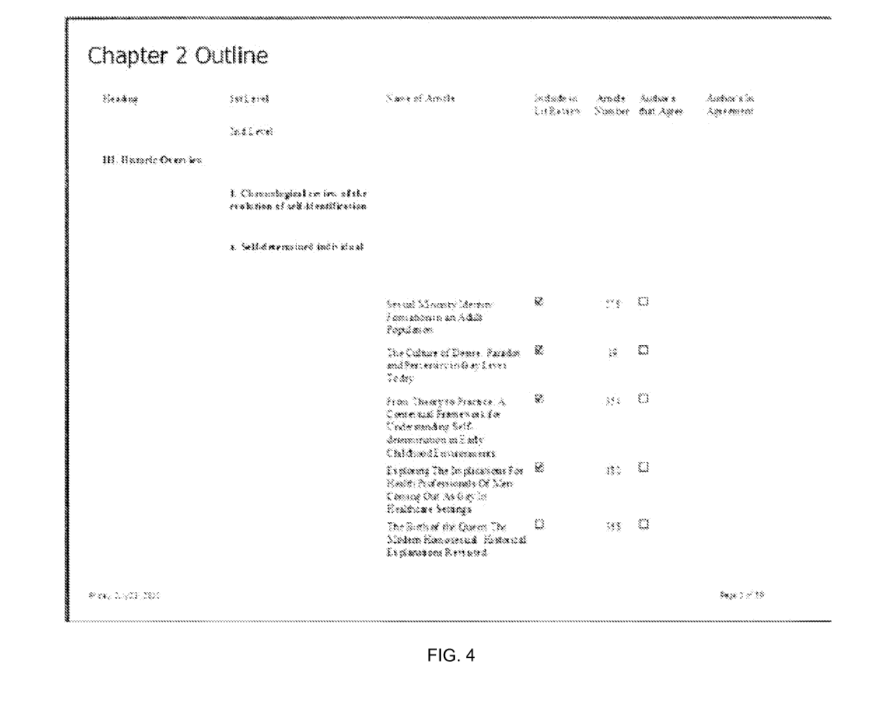

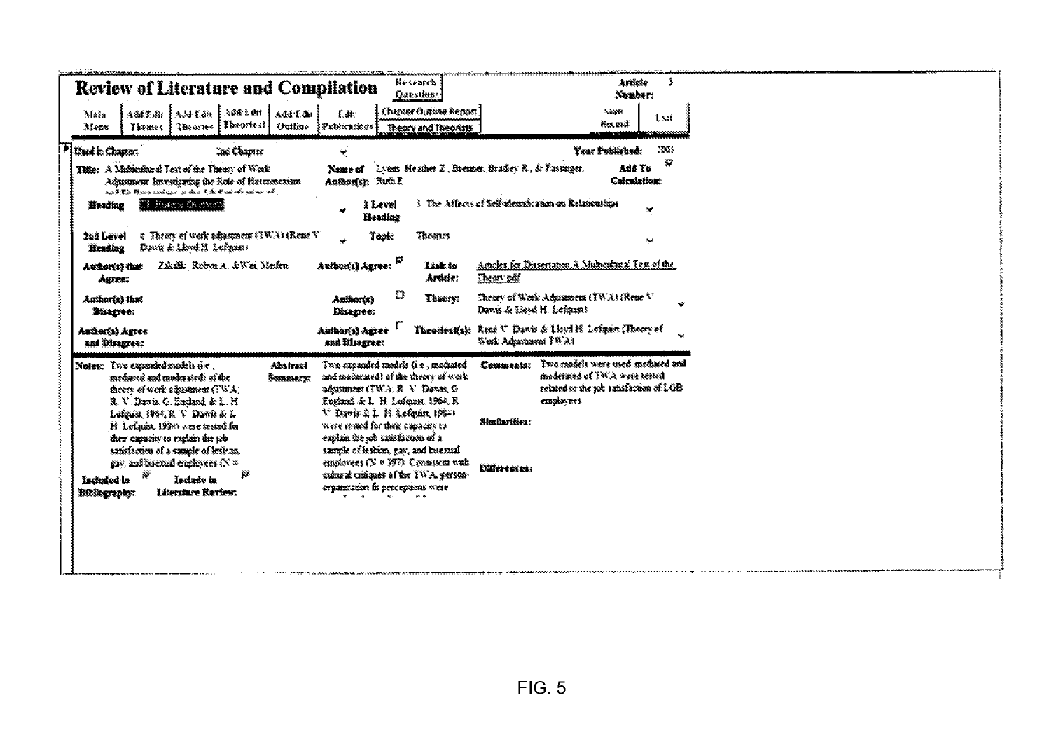

In another example, illustrated in FIGS. 4 and 5, the main document data includes chapter outlines that are facilitated by referential linkages between the main document data and the research data. In the main document data, the writer may enter a hierarchy of headings and subheadings to be displayed in the written work. Then, the writer may link each reference record to one or more of the entered headings and subheadings. The system may generate chapter outlines based on the headings and subheadings. The chapter outlines may list the references used under each subheading. The writer may include in the chapter outline as much information about each reference as he finds useful, including the date of publication, authors, theory, theorist, author agreement with theory, stored notes, and topic, so long as such information has been entered into the reference record as described below.

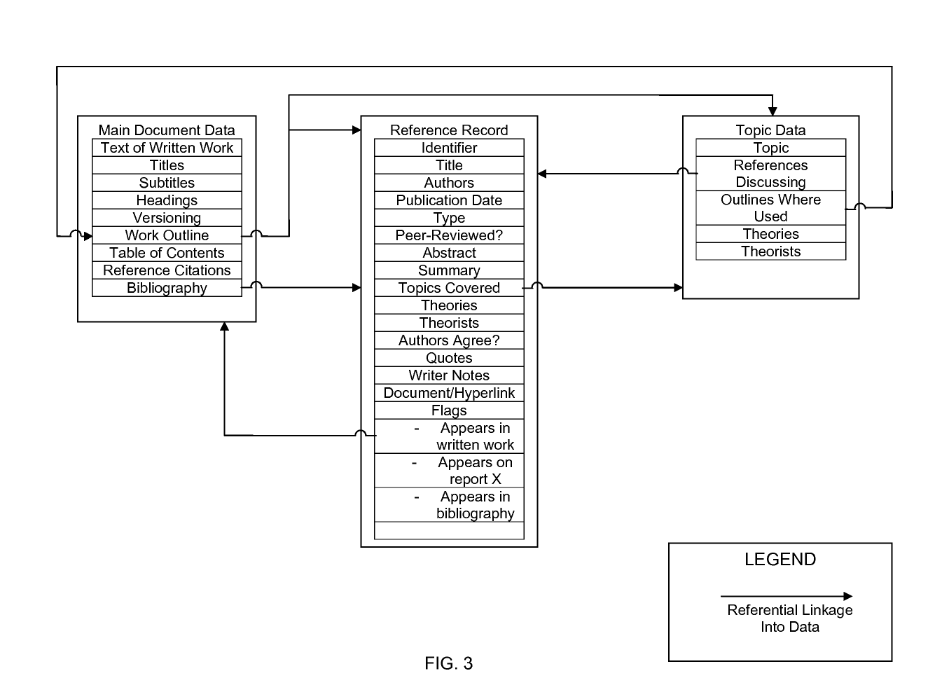

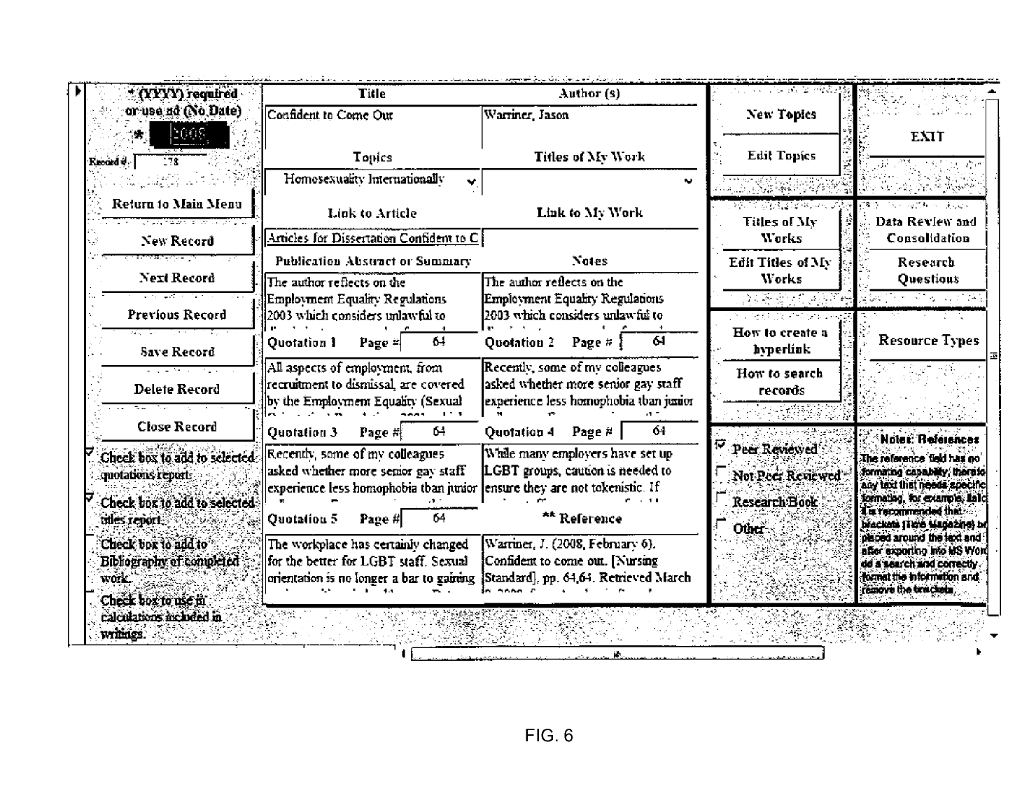

Research data relates to all information collected and synthesized for support of the analysis and conclusions presented in the written work. Research data may include bibliographic and user-entered information about each reference reviewed during the writer's research, as well as experimental data the writer has collected through his own experiments or studies. The data for each reference may be stored in one or more reference records assigned a unique reference identifier, which is preferably a record number. The reference record may include some or all of the following elements: title; authors; publication date; type of work, such as article, journal, or book; full citation; status as peer-reviewed or non-peer-reviewed work; abstract; summary; topics discussed, the topics preferably relating to the topic data described below; theory proposed or analyzed; identification of the relevant theorists and whether the authors agree or disagree with them; text and page number of quotes used in the written work; and the writer's notes about the reference. See FIGS. 3 and 6. The reference record may include one or more flags related to use of the reference in the system. Examples of flags include use in the written work, inclusion on the bibliography, citation in the literature review or another section of the written work, and inclusion on other reports such as the quotation or citation reports described below. The reference record may include referential linkages to the main document data, such as a pointer to the page of the written work on which the reference is cited. The reference record may include an electronic copy of the reference itself, or a link to access an electronic copy of the reference.

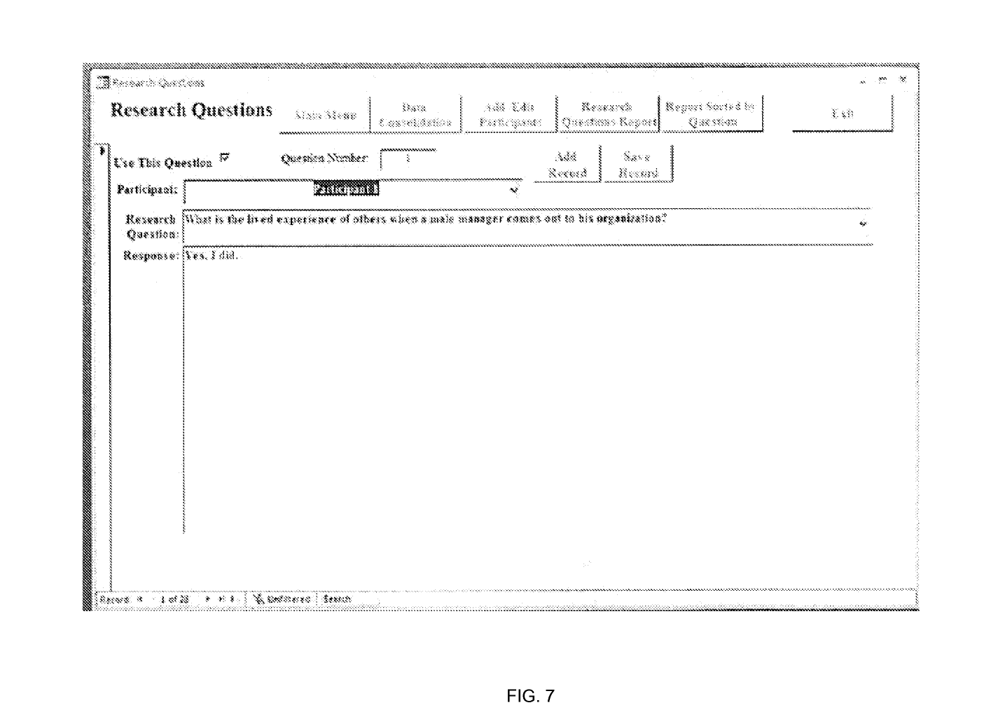

Experimental data pertains to the experiments or studies conducted by the writer himself, and the results collected therefrom. The type of experiment or study affects the experimental data to be collected. For example, experimental data in a so-called “natural” field of science may include the proposed hypothesis, methodologies employed, conditions present at the time of experimentation, collected results, and long-term archiving. In contrast, experimental data in a sociological or psychological study may include lists of survey participants, research questions, collected responses, and parsed analysis of the responses. In an example of a sociological dissertation, the writer conducts a survey on a certain sample of participants and collects the survey answers as results. See FIG. 7. The writer enters the survey questions into the system, and the system stores the survey questions as experimental data. The writer may select all or a subset of the survey questions and request the system to generate the survey. After conducting the survey, the writer may enter the survey participants, with or without personal identifying information, and record the survey results as experimental data. Experimental data may include referential linkages to the main document data, and may be referenced by the main document data for inclusion of the experiment parameters and results in the written work.

Topic data pertains to the high-level topics analyzed in the written work. Typically, the topic data may simply be an organizational category, containing a record for each topic, referential linkages to the reference records that discuss the topic, referential linkages to the experimental data that pertains to the topic, and referential linkages to the chapters and subchapters in the written work that review the topic. The topic data may further include the prevalent theories on the topic and the theorists that presented them.

Maintenance of Main Document Data

The system may store the content of the written work, including text, headings, and other project data, in any suitable electronic format, including database records containing raw text data or known self-referential document formats such as Adobe® Portable Document Format (“PDF”), Microsoft® Word (“.DOC”) format, or picture-formatted files. In the preferred embodiment, the written work is stored in the system in a formatted document uploaded by the user. The system may modify the content of the written work to include the most recent data, such as changes to research data. In one embodiment, the system performs a “tense replacement” of particular sections of the written work and may normalize the tense of verbs in that section. For example, in the dissertation writing process it is common to first write a proposal detailing what the writer expects to accomplish by writing the dissertation. Initially, the proposal is written in future tense because the actions have not been performed. The proposal is later incorporated into the final dissertation, and the system changes all verb tenses in the proposal to past tense because the actions are complete. In another embodiment, the system may place dynamic markers within the content of the written work mark where particular repeated material is located. The system may store an editable record of the repeated material. If the repeated material changes, the system uses the dynamic markers to update the repeated material in each location it appears. The system may maintain a versioning system to keep track of any such modifications.

Work outlines, including chapter and subchapter outlines, may similarly be uploaded by the user in a desired format. Preferably, however, work outlines are generated by the system using the input project data and stored in raw data format. The work outlines may be formatted to any suitable document format and exported for the user to save on his local computer.

Data Consolidation, Calculation, and Reporting

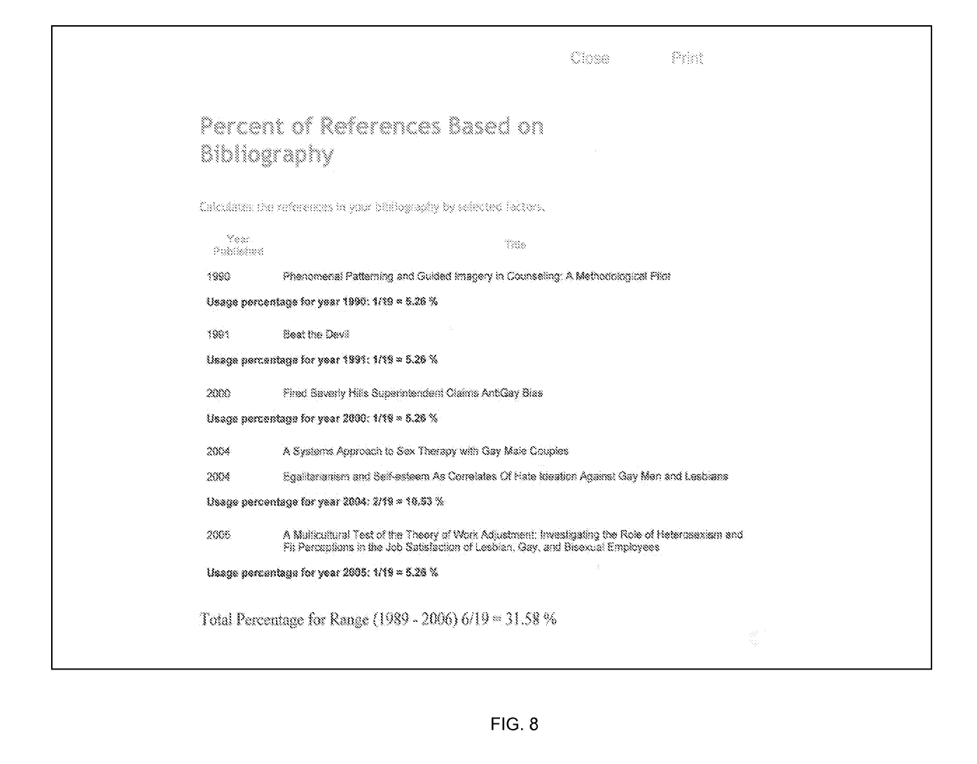

The system may be configured to consolidate the research data and present the consolidated data in several different reports. Many writing projects require certain minima to be met regarding the types, age, or other aspects of the body of references taken as a whole. For example, in a dissertation, the number of references cited that were published in the previous five years may be suggested to be at least 80 percent of the total number of references cited, or else the gap in the recent research must be explained in the written work. The system may analyze the reference records and calculate a ratio or percentage of references published per year compared to the total number of references, and then present a research-gap report giving the total percentage of all references that were published in the previous five years. See FIG. 8. In another example, the writer may benefit from organizing the body of references by theory, in order to ascertain the overall perspective of the various authors who have written about each theory. The reports may further include:

all or subsets of notes entered by user on references;

all or subsets of references presented by date, author, title, topic, or theory; p stored reference taxonomy;

quotations entered, flagged, or cited;

experiment or study results;

types of references reviewed and ratios or percentages among types;

percentage of all stored references cited in written work;

ratios or percentages of peer-reviewed to non-peer-reviewed references; and

ratios or percentages of references based on year published.

The reports and other documents produced or stored by the system may be reviewed within the system or printed according to the needs of the writer. The reports and other documents produced or stored by the system may be exported to a word processing or spreadsheet program.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

What is claimed is:

1. A method of electronically managing a large-scale writing project for producing a written work, the method comprising:
a. providing a user access over the internet to a server, the server being configured to receive project data from the user and to organize the project data;
b. receiving on the server project data from the user, the project data comprising main document data and research data; and
c. associating on the server the main document data with the research data.

2. The method of claim 1, wherein associating the main document data with the research data comprises creating one or more referential linkages between the main document data and the research data.

3. The method of claim 2, wherein:
a. the main document data comprises text of the written work; and
b. the research data comprises one or more reference records comprising information pertaining to a reference cited in the written work.

4. The method of claim 3, wherein at least one of the referential linkages comprises a reference citation in the written work that links to one of the reference records.

5. The method of claim 4, further comprising updating the reference citation when the reference record to which the reference citation links is changed.

6. The method of claim 3, wherein at least one of the referential linkages comprises a pointer from the reference record to one or more pages of the written work on which the reference is cited.

7. The method of claim 3, wherein the research data further comprises experiment data, and wherein at least one of the referential linkages links the written work to the experiment data.

8. The method of claim 3, wherein the project data further comprises one or more topic records, the method further comprising associating the topic data with the main document data and the research data.

9. The method of claim 1, further comprising analyzing the research data to generate a plurality of reports, wherein at least one of the reports comprises a research gap report.

10. A method of electronically managing a large-scale writing project for producing a written work, the method comprising:
a. creating a relational database on at least one server, the server being configured to store, organize, modify, and create project data comprising main document data and research data;
b. providing a user with secure access over the internet to the server;
c. receiving on the server project data from the user; and
d. associating on the server the main document data with the research data, the associating comprising creating one or more referential linkages between the main document data and the research data; and
e. storing the received project data and the referential linkages in the database.

11. The method of claim 10, wherein:
a. the main document data comprises text of the written work; and
b. the research data comprises one or more reference records comprising information pertaining to a reference cited in the written work.

12. The method of claim 11, wherein:
a. at least one of the referential linkages comprises a reference citation in the written work that links to one of the reference records; and
b. at least one of the referential linkages comprises a pointer from the reference record to one or more pages of the written work on which the reference is cited.

13. The method of claim 12, further comprising:
a. updating the reference citation when the reference record to which the reference citation links is changed; and
b. updating the pointer when the page on which the reference is cited changes.

14. The method of claim 12, wherein the project data further comprises one or more topic records, wherein the associating comprises creating one or more referential linkages between the topic records and one or both of the main document data and the research data, and wherein the method further comprises updating the referential linkages for the topic record when the data to which the referential linkages are linked is changed.

15. A method of electronically managing a large-scale writing project for producing a written work, the method comprising:
a. creating a relational database on at least one server, the server being configured to store, organize, modify, and create project data comprising:
i. main document data comprising:
1. text of the written work;
2. one or more bibliographies; and
3. one or more reference citations;
ii. research data comprising:
1. one or more reference records comprising information pertaining to a reference cited in the written work; and
2. experimental data comprising experiment parameters and results; and
iii. one or more topic records related to a topic; and
the server being further configured to:
receive some of the project data from a user;
add the received project data to the relational database;
create:
within each reference citation, a referential linkage to the relevant reference record;
within each reference record:
(a) one or more referential linkages to the text of the written work indicating where the reference is cited; and
(b) a referential linkage to each bibliography on which the reference appears; and
within each topic record:
(a) one or more referential linkages to the reference records pertaining to the topic;
(b) one or more referential linkages to the experimental data pertaining to the topic; and
(c) one or more referential linkages to parts of the written work where the topic is discussed; and
update each of the referential linkages when the data to which they the referential linkages are linked is changed;
b. providing a user with secure access over the internet to the server;
c. receiving on the server project data from the user; and
d. associating on the server the main document data, research data, and topic data, the associating comprising creating, within the reference citations, reference records, and topic records, the referential linkages that are supported by the project data received from the user.

16. The method of claim 15, wherein the information pertaining to a reference cited in the written work comprises:
a. the reference's title, authors, publication date, and type of work;
b. a full citation for the reference in a desired citation format;
c. the reference's abstract;
d. a list of topics discussed in the reference, each topic being a topic to which one of the topic records relates;
e. one or more theories presented in the reference;
f. one or more quotes used in the written work, including the page number of the reference on which the quote appears; and
g. one or more reference notes created by the user.

17. The method of claim 16, wherein the information pertaining to a reference cited in the written work further comprises an electronic copy of the reference.

18. The method of claim 17, wherein the reference records further comprise one or more flags each indicating a status selected from the group comprising:
a. whether or not the reference is cited in the written work;
b. whether or not the reference is cited in a particular section of the written work;
c. whether or not the reference is included on one or more of the bibliographies;
d. whether or not the reference is included on a report;
e. whether or not the reference is peer-reviewed or non-peer-reviewed; and
f. whether the authors agree or disagree with the theories in the reference.

19. The method of claim 15, wherein the server is further configured to produce a research gap report, the method comprising analyzing the research records to produce the research gap report.

20. The method of claim 15, further comprising using the server to perform a tense replacement within one or more parts of the written work.
